(19) United States
(12) Patent Application Publication
(10) Pub. No.: US 2002/0174365 A1
(43) Pub. Date: Nov. 21, 2002

(54) Enhanced communication scheme for objects in multi-host environments

(76) Inventors: Vadim Antonov, Belmont, CA (US); Mikhail Kourjanski, Albany, CA (US)

Correspondence Address: John P. Ward, BLAKELY, SOKOLOFF, TAYLOR & ZAFMAN LLP, 12400 Wilshire Boulevard, Seventh Floor, Los Angeles, CA, 90025-1026, US

(21) Appl. No.: 09/909,588

(22) Filed: Jul. 20, 2001

Related U.S. Application Data
(60) Provisional application No. 60/292,834, filed on May 21, 2001.
(60) Provisional application No. 60/293,628, filed on May 25, 2001.

(51) Int. Cl. H04L 9/00

(52) U.S. Cl. 713/201

(57) ABSTRACT

The disclosure is a method for dynamically matching a server and a client, the server and client being matched using an object library. A flow control of information is used to provide a buffer so there is no overflow of information to the recipient of the flow. The flow of information between the server and the client is provided through a secure communication. The server and client are also connected asynchronously.

The present application claims priority to the provisional filed application entitled Novel Dynamic Object Library Software Architecture, filed on May 21, 2001, Ser. No. 60/292,834, and the provisional filed application entitled Enhanced Communication Scheme for EOL Objects in Multi-Host Environments, filed on May 25, 2001, Ser. No. 60/293,628, both of which are incorporated by reference. The present application is also a continuation in part of the non-provisional filed application entitled Novel Dynamic Object Library Software Architecture, filed on Jul. 13, 2001, Ser. No. ______, which is also incorporated herein by reference.

### FIELD OF THE INVENTION

The present invention relates to the field of software architecture.

### BACKGROUND

Large data centers that are used to transmit customer information, credit card information or the like inherently have many problems. For most of the data centers, the biggest issues are lack of security, decreased quality of performance, scalability issues, and version flexibility to support application sharing among customers (multi-tenancy).

As the number of customers of a data center increases or if a data center has multiple locations serving multiple customers, security may decrease. Security issues are of great importance for these data centers that serve multiple clients (e.g., banking and financial institutions), as they may have competitors who are generally “hostile” toward one another. It is therefore necessary to provide a secure connection that allows client information to be sent through these data centers without compromising the security of the information.

With data centers being spread over multiple locations, decreases in guaranteed performance may also occur. It is necessary for a system in which shared use of a data center in multiple locations does not diminish performance.

A further issue with respect to the larger data centers is the problem of adaptability. In an application-sharing model, small customers share the same application. As customer use grows, the data centers should adapt to this increased growth. Unless adaptation can take place, the economies of scale will not allow for decreased costs. However, if the data centers are able to expand easily, the sharing of the applications becomes much more cost effective.

Version flexibility may also become a large problem because various customers may have different software version requirements, thus requiring multiple versions to be in use simultaneously. The architecture should be able to adapt to a variety of customer versions or the sharing of applications cannot work well. Additionally, the upgrade policy within the data centers should be flexible enough to allow client software to remain intact while server software is upgraded because it is unreasonable to demand a synchronous upgrade of all client software in the ASP setting.

Various software applications, including CORBA, Microsoft COM/DCOM, Enterprise Java Beans, and others, have attempted to address these problems. But none of these applications have been able to satisfactorily address all problems.

Thus a need exists for a software architecture that avoids those shortcomings, and allows information to be transmitted securely between a client and a server.

### SUMMARY OF THE INVENTION

In one embodiment, a method for dynamically matching a first and a second process, the first and second processes being matched using a library, the first and second processes utilizing a secure flow control of information and being connected asynchronously, is disclosed.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is an illustration of a structure in which the Exigen Object Library (EOL) would function between a transport layer and an application, according to one embodiment.

FIG. 2 is an illustration of a push and pull of information between a client and a server, according to one embodiment.

FIG. 3 is an illustration of a compiler that compiles a new object into a finished EOL object, according to one embodiment.

FIG. 4 is an illustration of a security model that allows for a secure connection between a client (first process) and a server (second process), according to one embodiment.

FIG. 5 is an illustration of an implementation of compatibility between a server and a client, according to one embodiment.

FIG. 6 is an illustration of a secure connection between processes using transfer points to ensure the secure connection between processes within one host and processes within another host, according to one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific configurations are set forth in order to provide a thorough understanding of the present invention. However, it will also be apparent to one skilled in the art that the present invention may be practiced without the specific details. In other instances, well-known features are omitted or simplified in order not to obscure the present invention.

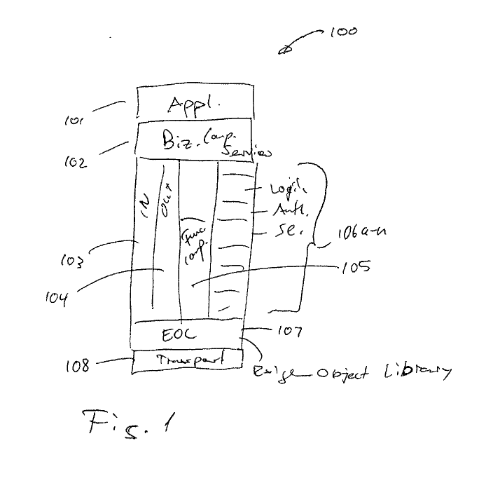

Referring now to FIG. 1, wherein an overview illustration of a structure in which the Exigen Object Library (EOL) would function between a transport layer and an application in accordance with one embodiment is shown. As illustrated, the structure 100 contains a running application 101, which uses an EOL application program interface (API), defined in detail in Appendix E. Beneath the running application is business computing services management 102. Below the business computing services management 102 are input channel 103 and output channel 104, functional compatibility modules (objects) 105 and services such as logic, authentication, security issues, etc. 106a-n. Beneath the input and output channels 103 and 104, the functional compatibility modules 105 and the services 106a-n is the Exigen Object Library (EOL) 107 that stores information for creating objects. The application program 101 uses the EOL 107 to access services 106a-n such as server computer authentication and the like. In one embodiment, the EOL 107 is above a transport layer 108 that is the bottom of the structure 100. The topology of the transport layer 108 may depend on the actual network, but in most cases it would typically be an IP network-type topology. Thus layers 107 and 106a-n provide an underlying foundation for the computing services 102 and applications 101 running on top. In alternative embodiments, different configurations could be used, that may include more or less of the features described.

The structure 100 is a message passing software architecture that allows information to be passed between a client (a first process) and a server (a second process). The transport layer 108 provides the connection between the client and the server so information may be passed.

Appendix A contains a complete description of the Exigen Object Library (EOL); and Appendix B describes the Exigen Object Definition Language (EODL), a novel definition language that defines elements of the EOL. Alternative embodiments may use stateless objects.

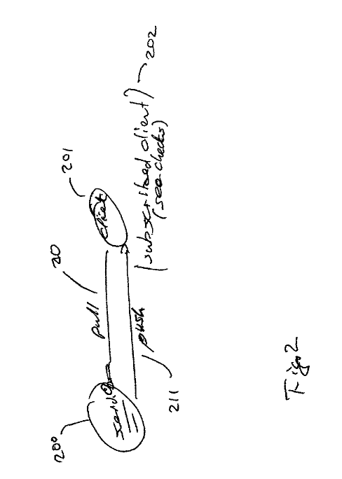

As is typical in a computing environment, FIG. 2 shows a client-server scenario, where a client 201 can either push 211 or pull 210 information from a server 200. A process using the EOL 107 may create an object and become a server 200 for that object. In one embodiment, the server 200 creates references to that object, passes those references to other processes and the processes then become clients 201 for that server object. The advantage of the EOL architecture is that it allows for dynamic type matching between the server 200 and the client 201, allowing for a compatibility match.

As an example, most object interface changes add new methods or fields. The object types that differ structurally may still be compatible, allowing the client 201 to safely continue to interact with the newer server 200. However, an object may change behavior in ways that break compatibility between the client 201 and the server 200. To ensure compatibility, type structures are compared. When client 201 and server 200 have object types with the same name and same behavior version numbers, they are considered to be of the same type and compatibility is acknowledged. Due to dynamic matching, no mandatory upgrade of the client side 201 is required or necessary, so therefore it is easier for one software instance to operate on different data sets, and vice versa. Also, scripts can be handed over dynamically, which allows execution of a script on a client 201 pushed 211 by a server 200. If the object types are matched from the server 200 to the client 201 and found compatible, then information may be pushed 211 or pulled 210 between them.

Another feature includes, instead of using a fixed connection, a flow control that is relied upon from the transport layer 108. When information is pushed 211 or pulled 210 from the client 201 to the server 200, the flow control provides a buffer at the origin of the flow so that there is no overflow of information to the recipient of the flow. For example, if a client 201 is sending information to a server 200, the flow control reduces the chances that the information will not overflow the server 200. The flow control chokes the stream going into the server 200, and the information provided by the client 201 is backed up on the client side 201, rather than the server side 200. This novel functionality allows data centers to be spread out over multiple locations, providing services to multiple users, while not overloading a server 200 with information from one specific client 201. Hence, such novel functionality adds an additional safety valve against clogging of multisite processing.

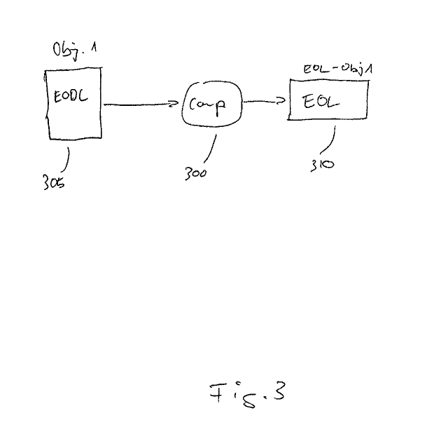

FIG. 3 shows a one-pass compiler 300 that can take a new object 305 and compile it in a single pass into a finished EOL object 310. The finished object 310 can then be embedded in the EOL layer 107 of FIG. 1.

As described in detail in Appendix B, sections 3-10.5, the EODL has descriptions for the following items: basic types, scripts, data streams (meaning open channels), dynamic state structure, security, cookies, and object reference.

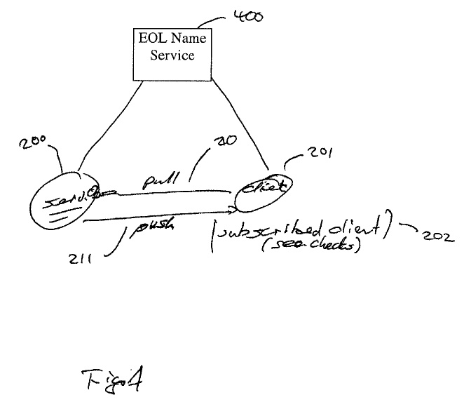

FIG. 4 describes the security model of the present invention. Security from clogging of information again relies upon the flow control previously described. Both the client 201 and the server 200 may check their respective security rights with an EOL name server 400. In another embodiment, the client 201 and server 200 may check their respective security rights with separate name servers. When a client 201 wants to access a server-side object, the client 201 needs a reference to that object. The service authentication process (one of the services 106a-n in FIG. 1) produces an initial “root” name server object. The name server system 400 locks up the requested object and gives the client 201 a cookie in return for verification. When the client 201 gets permission from the name server 400, the server 200 from which the client 201 wants to request services can verify permission directly from that name server 400. Once the security rights have been checked for the client 201 and the server 200, the client 201 and server 200 may communicate with each other by either pushing 211 or pulling 210 information. The lifecycle of the server object is decided by the server 200 itself—the client 201 does not manage the lifecycle.

If access permission is authorized, the object references may be stored or passed between different client 201 processes. The security model also includes a version compatibility check, so that a client 201 can only reach those versions for which it has been cleared.

Appendix C further describes the cooperation between server 200 and client 201 objects; and Appendix D describes the nameserver system, which is rather novel.

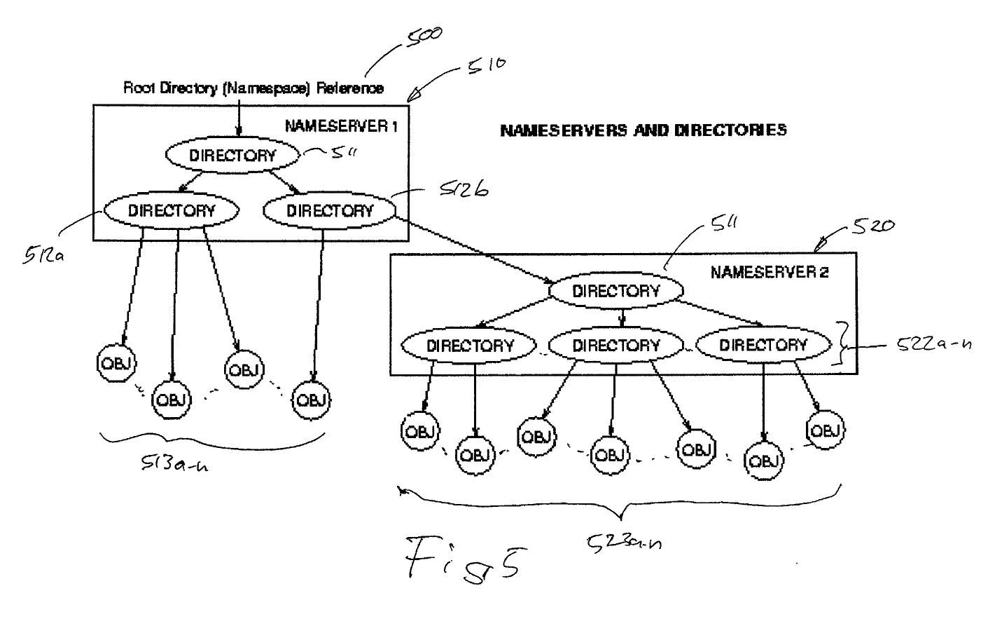

FIG. 5 shows an implementation of enhanced compatibility using a tree of nameservers and directories. Nameserver-1 510 holds the root (namespace) 500 of the system, which may have multiple layers of directories. In this example, directory 511, within nameserver-1 510, has its own root.

Subdirectories 512a and 512b manage objects 513a-n. One of the directories 512b in nameserver-1 510 then forms the root for nameserver-2 520. Nameserver-2 520 has its own internal root 521, and an additional layer of subdirectories 522a-n that manage objects 523a-n. Therefore, in essence, additional nameservers, directories, functional compatibility management servers, etc., are just additional clients to the root directory server. Each object 513a-n, 523a-n has a given name. The directory and nameserver managing that object then know the rights and locking capabilities of that object.

An application (i.e., activation manager application) is first run which uses the EOL to access a service such as computer authentication. A reference is then returned to the server's operational namespace 500 that contains the activation manager's configuration for the server and the references for the namespaces of individual server processes. The server process obtains its configuration from its namespace 500, as delegated by the activation manager, and performs initialization. Then using references to the user root nameserver from the configuration objects, the server process registers its service objects with these root nameservers, thus exposing the resources to users.

A further inventive aspect of this disclosure is that EOL programming provides a consistent way for asynchronous single-thread server implementations. The method invocation of an object, using EOL, is asynchronous (nonblocking)—while the server waits for the results, it can go on with other events in order to be as efficient as possible.

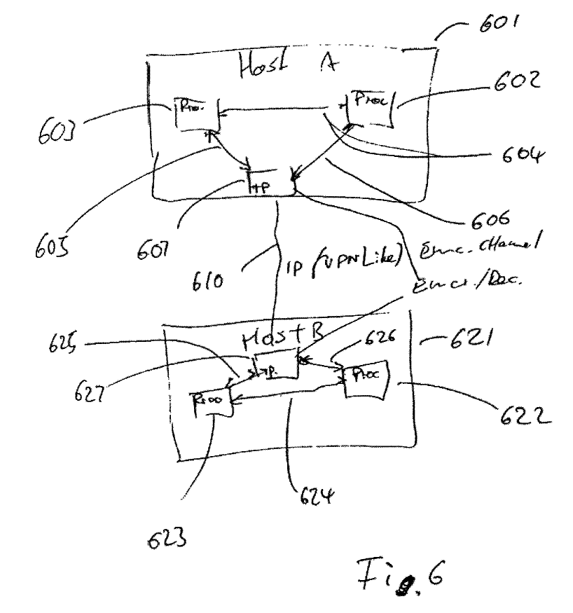

FIG. 6 shows an overview of the present invention—an architectural overview of software modules running on different systems. In this example, two hosts, host A 601 and host B 621, are in different locations. Running on each of these two hosts are two processes. On host A 601 processes 602 and 603 are run, and on host B 621 processes 622 and 623 are run. These processes all need to be able to communicate with one another.

In cases of intra-host communication, such as communication 604 between processes 602 and 603 or communication 624 between processes 622 and 623, no encryption is necessary because these communications 604 and 624 both remain within their own hosts 601 and 621, respectively. The assumption, then, is that the host has its own security system. However, if a process 602 needs to communicate with processes 622 or 623, it may have to go through an external link 610 (inter-host). If the two hosts are in different sites, then this external link 610 would have to go over an open and insecure network.

A solution for the need to provide secure inter-host communications for these processes is to provide two transfer points 607 and 627—a first transfer point 607 in host A 601 and a second transfer point 627 in host B 621. Each transfer point 607 and 627 acts as a concentrator for all inter-host communications, wrapping such communications in a secure, encrypted layer. The communications are then packaged IP-compatible, so any communication visible on a single-pipe connection link 610 uses, for example, standard IP protocol, but is protected VPN-like (i.e., protected with the same type of secure encryption of communication provided over a virtual private network).

Thus, if a first process 602 or 603 needs to contact a second process 622 or 623, it is routed as intra-host communication 605 or 606 to a first transfer point 607, encrypted (encryption module not specifically shown) and transferred through a single-pipe connection link 610 securely to host B 621 through a second transfer point 627. The second transfer point 627 then decrypts it (decryption module not shown) and transfers it as intra-host communication 626 or 627 to the second process 622 or 623. The separate host processes may be contacted, while ensuring secure communication.

This system can be further expanded so that each transfer process may talk to more than one peer at a time, and therefore does intelligent routing and bundling of all communication of all processes running inside the host at the same time. Such a system allows for very secure and completely transparent communication between hosts that have no secure communication means between them. As a result, the first process does not have to worry about whether the receiving process is local or not, and whether the link to some other host is secure or not. Instead, it simply calls up the identity of another process, and everything else is handled transparently by transfer processes.

The above embodiments can also be stored on a device or be read by a machine to perform instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Thus, a method for dynamically matching a first and a second process, the first and second processes being matched using a library, the first and second processes utilizing a secure flow control of information and being connected asynchronously, is disclosed.

What is claimed is:

1. A method comprising:
receiving an encrypted communication at a second transfer unit in a second host, the communication sent by a first process to be encrypted by a first transfer unit in a first host;
decrypting the communication at the second transfer unit; and
transferring the decrypted communication between the second transfer unit and a second process within the second host.

2. The method of claim 1, wherein a first plurality of processes are provided within the first host and a second plurality of processes are provided within the second host.

3. The method of claim 2, wherein the first plurality of processes within the first host can communicate securely with each other and the second plurality of processes within the second host can communicate securely with each other.

4. The method of claim 3, wherein the first plurality of processes can communicate simultaneously with each other and the second plurality of processes can communicate simultaneously with each other.

5. The method of claim 1, wherein the encrypted communication is transferred through a connection.

6. The method of claim 5, wherein the connection is a single-pipe connection.

7. A machine-readable storage medium tangibly embodying a sequence of instructions executable by the machine to perform a method, the method comprising the steps of:
receiving an encrypted communication at a second transfer unit in a second host, the communication sent by a first process to a first transfer unit to be encrypted in a first host;
decrypting the communication at the second transfer unit; and
transferring the decrypted communication between the second transfer unit and a second process within the second host.

8. The machine-readable medium of claim 7, wherein a first plurality of processes are provided within the first host and a second plurality of processes are provided within the second host.

9. The machine-readable medium of claim 8, wherein the first plurality of processes within the first host can communicate securely with each other and the second plurality of processes within the second host can communicate securely with each other.

10. The machine-readable medium of claim 9, wherein the first plurality of processes can communicate simultaneously with each other and the second plurality of processes can communicate simultaneously with each other.

11. The machine-readable medium of claim 7, wherein the encrypted communication is transferred through a connection.

12. The machine-readable medium of claim 11, wherein the connection is a single-pipe connection.

13. A system comprising:
a first process in a first host; and
a second process in a second host, the second process receiving communication from the first process, the communication having been encrypted by a first transfer unit in the first host and received by a second transfer unit within the second host to decrypt the communication in order to be transferred to the second process.

14. The system of claim 13, wherein a first plurality of processes are provided within the first host and a second plurality of processes are provided within the second host.

15. The system of claim 14, wherein the first plurality of processes within the first host can communicate securely with each other and the second plurality of processes within the second host can communicate securely with each other.

16. The system of claim 15, wherein the first plurality of processes can communicate simultaneously with each other and the second plurality of processes can communicate simultaneously with each other.

17. The system of claim 13, wherein the encrypted communication is transferred through a connection.

18. The system of claim 17, wherein the connection is a single-pipe connection.
